(19) United States
(12) Patent Application Publication
(10) Pub. No.: US 2021/0270312 A1
(43) Pub. Date: Sep. 2, 2021

(54) COMPACT ADJUSTABLE LINK

(71) Applicant: Bell Textron Inc., Fort Worth, TX (US)

(72) Inventors: George Matthew THOMPSON, Lewisville, TX (US); Jonathan Andrew KNOLL, Burleson, TX (US); Nicholas Ralph CARLSON, Dallas, TX (US)

(73) Assignee: Bell Textron Inc., Fort Worth, TX (US)

(21) Appl. No.: 16/806,205

(22) Filed: Mar. 2, 2020

(51) Int. Cl. F16C 7/06; F16B 7/18

(52) U.S. Cl. CPC F16C 7/06; B64C 27/605; F16C 2326/43; F16B 7/182

(57) ABSTRACT

An exemplary adjustable length link includes a first rod end having a body with a threaded socket, a second rod end having a threaded shaft and a sleeve having external threads cooperative with the threaded socket and a bore with internal threads cooperative with the threaded shaft.

### TECHNICAL FIELD

This disclosure relates in general to rotor systems, and more particularly, to an adjustable length link.

### BACKGROUND

This section provides background information to facilitate a better understanding of the various aspects of the disclosure. It should be understood that the statements in this section of this document are to be read in this light, and not as admissions of prior art.

Adjustable links are commonly used to connect elements in aircraft rotor systems. The traditional adjustable links are simple devices having opposing rod ends that are threadedly connected to each other by a threaded tube. The length of the link can be adjusted by threading one or both of the rod ends with the tube.

### SUMMARY

An exemplary adjustable length link includes a first rod end having a body with a threaded socket, a second rod end having a threaded shaft and a sleeve having external threads cooperative with the threaded socket and a bore with internal threads cooperative with the threaded shaft.

An exemplary aircraft rotor system includes an adjustable link coupled to a rotor blade, the adjustable link including a first rod end having a body with a threaded socket, a second rod end having a threaded shaft and a sleeve having external threads cooperative with the threaded socket and a bore with internal threads cooperative with the threaded shaft.

This summary is provided to introduce a selection of concepts that are further described below in the detailed description. This summary is not intended to identify key or essential features of the claimed subject matter, nor is it intended to be used as an aid in limiting the scope of claimed subject matter.

### BRIEF DESCRIPTION OF THE DRAWINGS

The disclosure is best understood from the following detailed description when read with the accompanying figures. It is emphasized that, in accordance with standard practice in the industry, various features are not drawn to scale. In fact, the dimensions of various features may be arbitrarily increased or reduced for clarity of discussion.

FIG. 1 illustrates an exemplary compact adjustable link.

FIG. 2 is a sectional view of an exemplary compact adjustable link.

FIG. 3 illustrates an exemplary aircraft rotor system incorporating a compact adjustable link.

FIG. 4 illustrates another exemplary aircraft rotor system incorporating a compact adjustable link.

FIG. 5 illustrates a portion of the exemplary aircraft rotor system of FIG. 4.

### DETAILED DESCRIPTION

It is to be understood that the following disclosure provides many different embodiments, or examples, for implementing different features of various illustrative embodiments. Specific examples of components and arrangements are described below to simplify the disclosure. These are, of course, merely examples and are not intended to be limiting. For example, a figure may illustrate an exemplary embodiment with multiple features or combinations of features that are not required in one or more other embodiments and thus a figure may disclose one or more embodiments that have fewer features or a different combination of features than the illustrated embodiment. Embodiments may include some but not all the features illustrated in a figure and some embodiments may combine features illustrated in one figure with features illustrated in another figure. Therefore, combinations of features disclosed in the following detailed description may not be necessary to practice the teachings in the broadest sense and are instead merely to describe particularly representative examples. In addition, the disclosure may repeat reference numerals and/or letters in the various examples. This repetition is for the purpose of simplicity and clarity and does not itself dictate a relationship between the various embodiments and/or configurations discussed.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms such as “inboard,” “outboard,” “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction. As used herein, the terms “connect,” “connection,” “connected,” “in connection with,” and “connecting” may be used to mean in direct connection with or in connection with via one or more elements. Similarly, the terms “couple,” “coupling,” and “coupled” may be used to mean directly coupled or coupled via one or more elements.

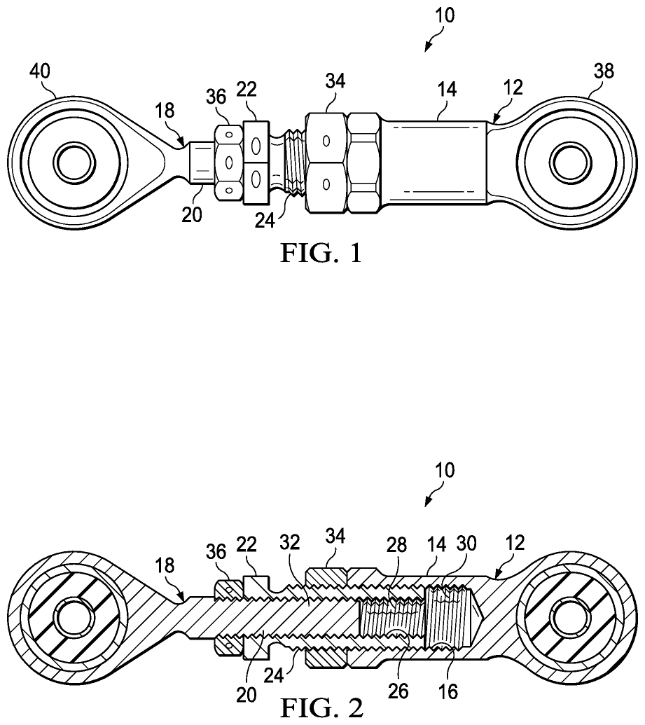

FIGS. 1 and 2 illustrate an exemplary adjustable length link generally denoted by the reference number 10. Adjustable length link 10 includes a first rod end 12 having a body 14 with a threaded socket 16, a second rod end 18 having a threaded shaft 20 and a sleeve 22 having external threads 24 cooperative with the threaded socket 16 and a bore 26 with internal threads 28 cooperative with the threaded shaft 20. The cooperative female threads 30 of threaded socket 16 and external threads 24 may have a larger or smaller pitch than the cooperative male threads 32 of threaded shaft 20 and internal threads 28. In an exemplary embodiment, female threads 30 and external threads 24 are coarse threads and male threads 32 and internal threads 28 are fine threads.

In the illustrated embodiment, a first jam nut 34 is threadedly connected to external threads 24 of sleeve 22. In use, sleeve 22 is threaded with threaded socket 16 to generally set the desired length of adjustable link 10. Jam nut 34 is threaded along external threads 24 of sleeve 22 and into engagement with body 14 securing first rod end 12 and sleeve 22 in a fixed position relative to one another. Exemplary adjustable link 10 also includes a second jam nut 36 threadedly connected to threaded shaft 20. After second rod end 18 is threaded with sleeve 22 to achieve the desired length of adjustable link 10, second jam nut 36 is threaded into engagement with sleeve 22 securing second rod end 18 and sleeve 22 in a fixed position relative to one another. Jam nuts 34, 36 are also used to secure the connector ends of the first and second rod ends relative to one another.

First rod end 12 includes a connector 38 opposite from threaded socket 16 and second rod end 18 includes a connector 40 opposite from threaded shaft 20. Connectors 38, 40 maybe bearings. Adjustable link 10 can be used in various operational systems and is not limited to the illustrated examples. Adjustable link 10 is suited for example for use in aircraft rotor systems, in particular in compact spaces. Adjustable link 10 may be used in non-rotor systems, for example securing an engine or motor to a mount.

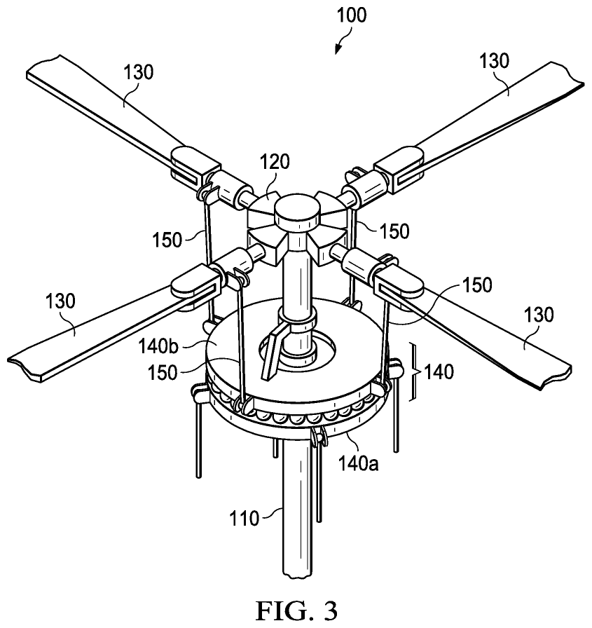

FIG. 3 illustrates an exemplary aircraft rotor system generally denoted by the numeral 100. Teachings of certain embodiments relating to rotor systems may apply to rotor lift, forward flight, and anti-torque rotor systems, such as tiltrotor, tilt-wing, ducted rotor, distributed rotor systems, and helicopter rotor systems. It should be appreciated that teachings herein apply to manned and unmanned aerial vehicles. As will be understood by those of ordinary skill in the art with benefit of this disclosure that adjustable link 10 is particularly suited for use in smaller aircraft and compact systems, including without limitation unmanned aerial vehicles.

In this example, rotor assembly 100 includes a drive shaft 110, a drive assembly 120, blades 130, a swashplate 140, and compact adjustable links used as pitch links 150. Drive shaft 110 and drive assembly 120 are mechanical components for transmitting torque and/or rotation. Drive shaft 110 and drive assembly 120 may represent components of a drive train, which may also include an engine, a transmission, differentials, and the final drive (e.g., blades 130). In operation, drive shaft 110 receives torque or rotational energy and rotates drive assembly 120. Rotation of drive assembly 120 causes blades 130 to rotate about drive shaft 110.

Swashplate 140 translates input via flight controls into motion of blades 130. Because blades 130 are typically spinning when the aircraft is in flight, swashplate 140 may transmit flight controls from the non-rotating fuselage to the rotating drive assembly 120 and/or blades 130.

In some examples, swashplate 140 may include a stationary swashplate 140a and a rotating swashplate 140b. Stationary swashplate 140a does not rotate with drive shaft 110, whereas rotating swashplate 140b does rotate with drive shaft 110. In the example of FIG. 3, pitch links 150 connect rotating swashplate 140b to blades 130. In operation, tilting stationary swashplate 140a causes rotating swashplate 140b to tilt, which in turn moves pitch links 150 up and down. Moving pitch links 150 up and down changes the pitch of blades 130.

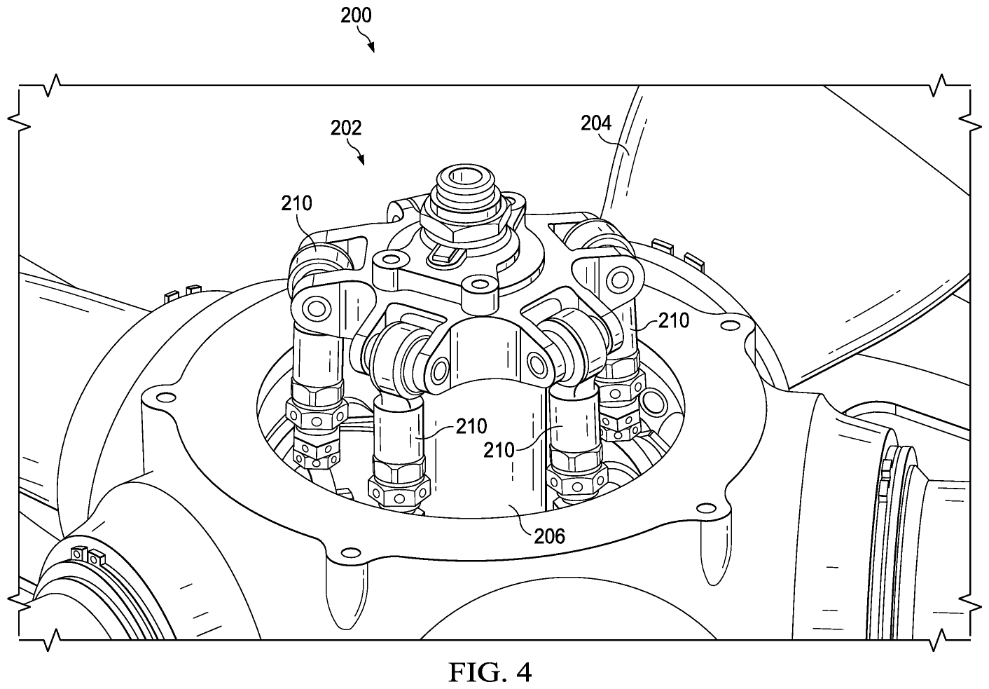

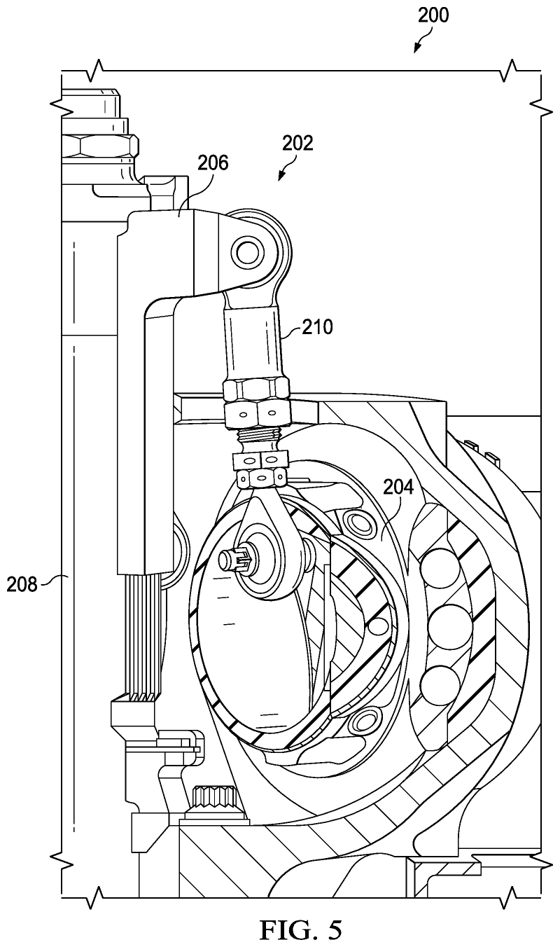

FIGS. 4 and 5 illustrate another exemplary aircraft rotor system 200 including a pitch assembly 202 connected to rotor blades 204. Pitch assembly 202 controls the collective pitch of rotor blades 204. Pitch assembly 202 includes a pitch hub 206 connected to mast 208 and configured to translate along mast 208 parallel to the central rotational axis. Compact adjustable links 210 are coupled to pitch hub 202 and to the four rotor blades. In some implementations, pitch hub 206 connects to a single degree of freedom collective control system to collectively control the pitch of each of the rotor blades. Pitch hub 206 is in a cross-head shape to allow collective pitch control of the rotor blades.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure and that they may make various changes, substitutions, and alterations without departing from the spirit and scope of the disclosure. The scope of the invention should be determined only by the language of the claims that follow. The term “comprising” within the claims is intended to mean “including at least” such that the recited listing of elements in a claim are an open group. The terms “a,” “an” and other singular terms are intended to include the plural forms thereof unless specifically excluded.

What is claimed is:

1. An adjustable length link comprising:
a first rod end having a body with a threaded socket;
a second rod end having a threaded shaft; and
a sleeve having external threads cooperative with the threaded socket and a bore with internal threads cooperative with the threaded shaft.

2. The adjustable length link of claim 1, wherein the external threads and the internal threads have different thread pitches.

3. The adjustable length link of claim 1, further comprising a sleeve jam nut threadedly connected to the external threads of the sleeve to engage the body and secure the first rod end and the sleeve in a fixed position relative to one another.

4. The adjustable length link of claim 1, further comprising a shaft jam nut threadedly connected to the threaded shaft to engage the sleeve and secure the sleeve and the second rod in a fixed position relative to one another.

5. The adjustable length link of claim 1, wherein the first rod end comprises a first connector and the second rod end comprises a second connector.

6. The adjustable length link of claim 5, wherein the first connector and the second connectors are bearings.

7. The adjustable length link of claim 1, further comprising a sleeve jam nut threadedly connected to the external threads of the sleeve to engage the body and secure the first rod end and the sleeve in a fixed position relative to one another; and
a shaft jam nut threadedly connected to the threaded shaft to engage the sleeve and secure the sleeve and the second rod in a fixed position relative to one another.

8. The adjustable length link of claim 7, wherein the external threads and the internal threads have different thread pitches.

9. The adjustable length link of claim 7, wherein the first rod end comprises a first connector and the second rod end comprises a second connector, wherein the first connector and the second connector are bearings.

10. The adjustable length link of claim 10, wherein the external threads and the internal threads have different thread pitches.

11. An aircraft rotor system comprising:
an adjustable link coupled to a rotor blade, the adjustable link comprising:
a first rod end having a body with a threaded socket;
a second rod end having a threaded shaft; and
a sleeve having external threads cooperative with the threaded socket and a bore with internal threads cooperative with the threaded shaft.

12. The aircraft rotor system of claim 11, wherein one of the first rod end and the second rod end is coupled to the rotor blade and the other one of the first rod end and the second rod end is coupled to a hub mounted with a mast.

13. The aircraft rotor system of claim 11, wherein the external threads and the internal threads have different thread pitches.

14. The aircraft rotor system of claim 11, further comprising a sleeve jam nut threadedly connected to the external threads of the sleeve to engage the body and secure the first rod end and the sleeve in a fixed position relative to one another.

15. The aircraft rotor system of claim 11, further comprising a shaft jam nut threadedly connected to the threaded shaft to engage the sleeve and secure the sleeve and the second rod in a fixed position relative to one another.

16. The aircraft rotor system of claim 11, wherein the first rod end comprises a first connector and the second rod end comprises a second connector.

17. The aircraft rotor system of claim 16, wherein the first connector and the second connectors are bearings.

18. The aircraft rotor system of claim 11, further comprising a sleeve jam nut threadedly connected to the external threads of the sleeve to engage the body and secure the first rod end and the sleeve in a fixed position relative to one another; and
a shaft jam nut threadedly connected to the threaded shaft to engage the sleeve and secure the sleeve and the second rod in a fixed position relative to one another.

19. The aircraft rotor system of claim 18, wherein the external threads and the internal threads have different thread pitches.

20. The aircraft rotor system of claim 19, wherein the first rod end comprises a first connector and the second rod end comprises a second connector, wherein the first connector and the second connector are bearings.
